(19) United States
(12) Patent Application Publication
(10) Pub. No.: US 2007/0253875 A1
(43) Pub. Date: Nov. 1, 2007

(54) Hydrogen supply for micro fuel cells

(76) Inventors: Chowdary R. Koripella, Scottsdale, AZ (US); Dave P. Beacco, Phoenix, AZ (US); Allison M. Fisher, Chandler, AZ (US); Billy J. Mylan, Mesa, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/413,709

(22) Filed: Apr. 28, 2006

(51) Int. Cl. B01J 8/08; H01M 8/06

(52) U.S. Cl. 422/232; 429/19

(57) ABSTRACT

A disposable, compact, and efficient storage apparatus (10) contains a fuel source (24) and water for supplying hydrogen fuel (36) to a micro-fuel cell. The storage apparatus comprises a housing defining a fuel source chamber (14) and a plurality of water chambers (12), and one or more polymer crystals (22) containing water positioned within each of the water chambers (12). The fuel source (24), such as a chemical hydride mixed with a catalyst, is positioned within the fuel source chamber (14), wherein the water in each of the water chambers (12) is selectively allowed to migrate to the fuel source chamber (14) to contact the solid fuel, thereby producing the hydrogen fuel (36) at a desired flow rate and temperature. A conduit (32) supplies the hydrogen fuel (36) produced within the housing to the fuel cell (38).

### FIELD OF THE INVENTION

The present invention generally relates to micro-fuel cells and more particularly to a storage apparatus containing a fuel source and water for supplying hydrogen fuel to a micro-fuel cell.

### BACKGROUND OF THE INVENTION

Rechargeable batteries are the primary power source for cell phones and various other portable electronic devices. The energy stored in the batteries is limited. It is determined by the energy density (Wh/L) of the storage material, its chemistry, and the volume of the battery. For example, for a typical Li ion cell phone battery with a 250 Wh/L energy density, a 10 cc battery would store 2.5 Wh of energy. It could last for a few hours to a few days depending on the usage. Recharging always requires an electrical outlet. The limited amount of stored energy and the frequent recharging are major inconveniences with the batteries. There is a need for a longer lasting, easily recharging solution for cell phone power sources. One approach to fulfill this need is to have a hybrid power source with a rechargeable battery and a method to trickle charge the battery. Important considerations for an energy conversion device to recharge the battery include power density, energy density, size and the efficiency of energy conversion.

Energy harvesting methods such as solar cells, thermoelectric generators using ambient temperature fluctuations, and piezoelectric generators using natural vibrations are very attractive power sources to trickle charge a battery. However, the energy generated by these methods is small, usually only a few milliwatts, and it requires a large volume to generate sufficient power in the hundred of milliwatts needed, making it unattractive for cell phone type applications.

An alternative approach is to carry a high energy density fuel and convert this fuel energy into electrical energy with high efficiency to recharge the battery. Radioactive isotope fuels with high energy density are being investigated for portable power sources. However, the power densities are low with this approach, and also there are safety concerns with the radioactive materials. This is an attractive power source for remote sensor type applications, but not for cell phone power sources. Among the various other energy conversion technologies, the most attractive one is the fuel cell technology because of its high efficiency of energy conversion and the demonstrated feasibility to miniaturize with high efficiency.

Fuel cells with active control systems and high operating temperature fuel cells such as active control direct methanol or formic acid fuel cells (DMFC or DFAFC), reformed hydrogen fuel cells (RHFC) and solid oxide fuel cells (SOFC) are complex systems and very difficult to miniaturize to the 2-5 cc volume needed for cell phone application. Passive air breathing hydrogen fuel cells, passive DMFC or DFAFC, and biofuel cells are attractive systems for this application. However, in addition to the miniaturization issues, other concerns include supply of hydrogen for hydrogen fuel cells, life time and energy density for passive DMFC and DFAFC, and life time, energy density and power density with biofuel cells.

Conventional DMFC and DFAFC designs comprise planar, stacked layers for each cell. Individual cells may then be stacked for higher power, redundancy, and reliability. The layers typically comprise graphite, carbon or carbon composites, polymeric materials, metal such as titanium and stainless steel, and ceramic. The functional area of the stacked layers is restricted, usually on the perimeter, by vias for bolting the structure together and passage of fuel and an oxidant along and between cells. Additionally, the planar, stacked cells derive power only from a fuel/oxidant interchange in a cross sectional area (x and y coordinates).

To design a fuel cell/battery hybrid power source in the same volume as the current cell phone battery (10 cc-2.5 Wh), a smaller battery and a fuel cell with high power density and high efficiency, and a high energy density fuel supply would be required to achieve an overall energy density higher than that of the battery alone. For example, for a 4-5 cc (1-1.25 Wh) battery to meet the peak demands of the phone, the fuel cell would need to fit in 1-2 cc, with the fuel taking up the rest of the volume. The power output of the fuel cell needs to be 0.5 W or higher to be able to recharge the battery in a reasonable time. Most development activities on small fuel cells are attempts to miniaturize the traditional fuel cell designs into a small scale, and the resultant systems are still too big for cell phone application. A few micro fuel cell development activities have been disclosed using traditional silicon processing methods in planar fuel cell configurations, and in few cases using porous silicon (to increase the surface area and power densities). See for example, U.S. Patent/Application Numbers 2004/0185323, 2004/0058226, 6,541,149, and 2003/0003347. However, the power densities of the air breathing planar hydrogen fuel cells are typically in the range of 50-100 mW/cm². To produce 500 mW, it would require 5 cm² or more active area. The operating voltage of a single fuel cell is in the range of 0.5-0.7V. At least four to five cells need to be connected in series to bring the fuel cell operating voltage to 2-3V for efficient DC-DC conversion to 4V in order to charge the Li ion battery. Therefore, the traditional planar fuel cell approach will not be able to meet the requirements in 1-2 cc volume for a fuel cell in the fuel cell/battery hybrid power source for cell phone use. The 3D micro fuel cell architecture described in the above mentioned patent applications attempt to solve this problem by providing more surface area to increase the power density as well as provide a modular approach to power output by adding the fuel cell modules as required. However, to achieve over all high energy density for the power source, a high energy density fuel supply needs to fit in a small volume.

A high energy density fuel source and controlled delivery of the fuel (typically hydrogen) are two important issues in the development of micro fuel cells with high energy density for portable power applications, e.g., cell phones. Among known options for the supply of hydrogen such as the H₂ storage in compressed cylinders, carbon nanotubes, metal hydrides, or in metal organic frame works, the amount of hydrogen storage is limited and the energy density is typically low and they are not competitive for the specified application. Storage of hydrogen in chemical hydrides is attractive, but it requires a controlled method of releasing hydrogen gas from the chemical hydride. Once released, the storage of hydrogen gas is also difficult. Leakage caused by over production (in addition to environmental concerns) reduces energy density, and under production reduces fuel cell output. Therefore, a controlled production/flow rate is desired. Additionally, overproduction (quick chemical consumption of materials) results in a high temperature which is undesirable for material longevity and user comfort. It is further desired to maintain a small volume while avoiding consumption of power.

Accordingly, it is desirable to provide a compact and efficient storage apparatus containing a fuel source and water for supplying fuel in a controlled manner to a micro-fuel cell. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A compact and efficient storage apparatus contains a fuel source and water for supplying hydrogen fuel to a micro-fuel cell. The storage apparatus comprises a housing defining a fuel source chamber and a plurality of water chambers, and one or more polymer crystals containing water positioned within each of the water chambers. The fuel source, such as a chemical hydride mixed with a catalyst, is positioned within the fuel source chamber, wherein the water in each of the water chambers is selectively allowed to migrate to the fuel source chamber to contact the solid fuel, thereby producing the hydrogen fuel at a desired flow rate and temperature. A conduit supplies the hydrogen fuel produced within the housing to the fuel cell.

### BRIEF DESCRIPTION OF THE DRAWINGS

The present invention will hereinafter be described in conjunction with the following drawing figures, wherein like numerals denote like elements, and

FIG. 1 is a top cross sectional view of an exemplary embodiment.

FIG. 2 is a perspective view of a hybrid power source incorporating the exemplary embodiment.

FIG. 3 is a top cross sectional view of the exemplary embodiment and block diagram of a fuel cell.

FIG. 4 is a graph showing fuel flow and temperature for a known method of mixing water with a fuel source.

FIG. 5 is a graph showing fuel flow and temperature for the exemplary embodiment.

FIGS. 6-13 are partial cross sectional views showing the layers as fabricated in accordance with an exemplary embodiment of the present invention; and

FIG. 14 is a partial cross sectional top view of FIG. 13.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A high energy density fuel source and controlled delivery of the fuel for a micro-fuel cell is described herein. Water is stored in super adsorbent polymer crystals, or a hydro gel material, within a plurality of chambers. Each of the chambers are selectively “opened” so the water may migrate and mix with a solid fuel to provide hydrogen at a low temperature and at a low rate to a micro-fuel cell. The fuel is dense and compact, thereby conserving space, and the water is conveniently packaged for long term storage. The choice of the fuel (solid fuel source), the other reactant (which is water) in a convenient form (adsorbed in a polymer) and packaged into small reaction chambers separated by a controlled valve which can be opened as desired for the reaction to proceed in a safe, slow rate to produce hydrogen gas at the desired 1-3 sccm rate needed for the micro fuel cells are described in this application.

The most promising approaches are the hydrogen storage in chemical hydrides such as sodium borohydride or lithium borohydride and such or the reaction of activated sodium silicate or other metals with water. The reaction of activated metals with water is very vigorous, it is an exothermic reaction releasing lot of heat quickly and it is very difficult to control the reaction rate. Reaction of sodium borohydride and water for the generation of hydrogen is well known in the literature. For example, the article titled “Sodium Borohydride, Its hydrolysis and its use as a reducing agent and in the generation of hydrogen” by H. I Schlesinger, Herbert C. Brown, A. E. Finholt, James R. Gilbreath, Henry R. Hoekstra and Earl K. Hyde, J. Am. Chem. Soc; 1955; 75(1) 215-219 describes the reaction of sodium borohydride with water and the influence of various catalysts, and pH of water (addition of acid to the water) for this reaction. Generation of hydrogen by the reaction of sodium borohydride solution with a catalyst is also known. However the energy density of the fuel in this case is low due to the use of a dilute fuel solution. For the design of a high energy density fuel source, ideally the reaction of solid sodium borohydride (optionally mixed with a catalyst) with water is preferred. Once hydrogen is produced it will be supplied to the fuel cell to generate power. Control of the sodium borohydride with water reaction to supply only sufficient hydrogen for the fuel cell reaction is needed. To achieve high energy density for the power source, complete reaction of the fuel source (ex: sodium borohydride mixed with a catalyst) with water is also desired to maximize the fuel utilization and increase the overall system efficiency.

Referring to FIG. 1, a storage apparatus 10 in accordance with the exemplary embodiment includes a first row 12 and a second row 14. The first row 12 comprises a plurality of chambers 16 and the second row comprises an equal plurality of chambers 18, wherein each chamber 16 is positioned adjacent one of the chambers 18 and separated therefrom by a membrane 20. The membrane 20 comprises a material that may be destructively opened, for example, by the application of an electrical current therethrough. The membrane 20 may comprise, for example, a thermoplastic. The remaining sides of the chambers 16 and 18 preferably comprise a plastic material, but may comprise any light weight, sturdy material that will contain the materials stored therein.

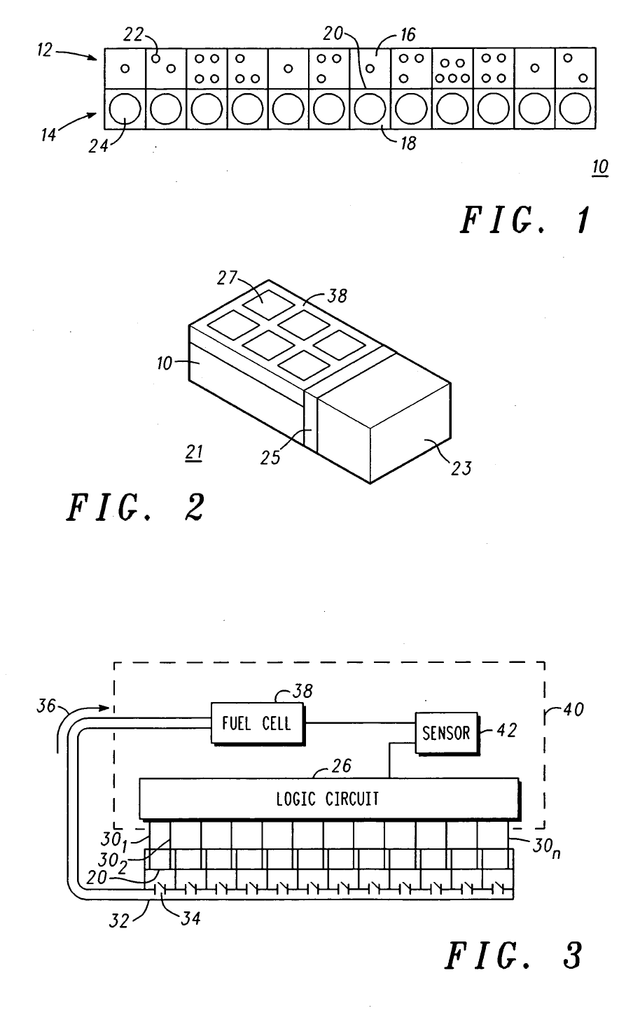

FIG. 2 is a perspective view of a hybrid power source 21 in accordance with the exemplary embodiment, with a fuel cell 38 (occupying 1 cc), the storage apparatus 10 (4 cc), a battery 23 (3 cc) and an optional super capacitor 25 (1 cc, wherein the battery 23 would occupy 2 cc), all to fit in an 8 cc volume typical for a Li ion battery used in cell phone applications. In the configuration shown in FIG. 2, six cells 27 are connected in series. The target operating voltage for each cell is 0.7V for a total output voltage of 6×0.7V=4.2V. If the total output current is 0.125 A, then the total target power output is 0.125 A×4.2 V=0.525 W. To produce 125 mA current from the fuel cell stack, the moles of hydrogen required is:
It/zF=(0.125 A×60 sec)/(2*96,487)=3.89×10⁻⁵ moles,
where I=current in amps,
t=time in seconds,
z=number of electrons participating in the reaction (2 in this case), and
F=Faraday's constant (96,485),
   or an H₂ flow of 0.87 sccm. If the fuel cell is operating at 50% efficiency, then 1.74 sccm of H₂ is required.

Each of the chambers 16 of row 12 have one or more polymer crystals 22, e.g., polyacrylamide crystals, having water stored therein. Each of the chambers 18 of row 14 have a fuel source 24 stored therein. The fuel source preferably comprises solid fuel pellets comprising a mixture of sodium borohydride (NaBH₄) powder and a catalyst boron oxide (B₂O₃) powder, but may comprise any combination of a fuel and catalyst that combines with water to produce hydrogen, e.g., sodium borohydride (NaBH₄) and cobalt chloride (CoCl₂). Although the solid fuel pellets are a convenient method of storing the fuel source 24, the fuel may be stored in any form, including a powder, gel, or liquid. Furthermore, though the fuel source preferably is stored in a plurality of chambers 18, an alternative embodiment comprises a single chamber containing the fuel source coupled to the plurality of chambers 16.

When a membrane 20 is opened (in a manner described hereinafter) in one of the chambers 16, water stored in the polymer crystals 22 positioned therein will migrate and mix with the fuel source 24 in the adjacent chamber 18. The mixing of NaBH₄ and B₂O₃ results in a powder sodium boron oxide (NaBO₂) and hydrogen (H2) being produced.

An example of one method of activating the storage apparatus 10 within a fuel cell apparatus is shown in FIG. 3. A logic circuit 26 comprises a plurality of conductors 30₁ through 30ₙ, two each of which are coupled to each one of the membranes 20, wherein a current applied therethrough will open a valve between the two chambers and allow the water to react with the solid sodium borohydride fuel. The valve can be designed to be operated electromagnetically, electrostatically, or destructively by a resistive method, e.g., heat dissolves a low melting valve material opening the gap in the membrane. More specifically, when a voltage is placed across the conductors 30₁ and 30₂, a current will flow through the membrane 20 coupled therebetween, thereby “opening” the membrane. A conduit 32 positioned adjacent the chambers 18 receives through openings 34 the hydrogen produced by the chemical reaction of the mixing of the fuel source and water. The conduit supplies the hydrogen 36 to the fuel cell 38. A sensor 42 senses when the fuel cell 38 current has diminished below a threshold, whereby the logic circuit 26 applies a voltage across another pair of conductors, e.g., 30₁-30ₙ, to open another membrane 20 between another set of chambers 12 and 14 and provide additional hydrogen to the fuel cell 38.

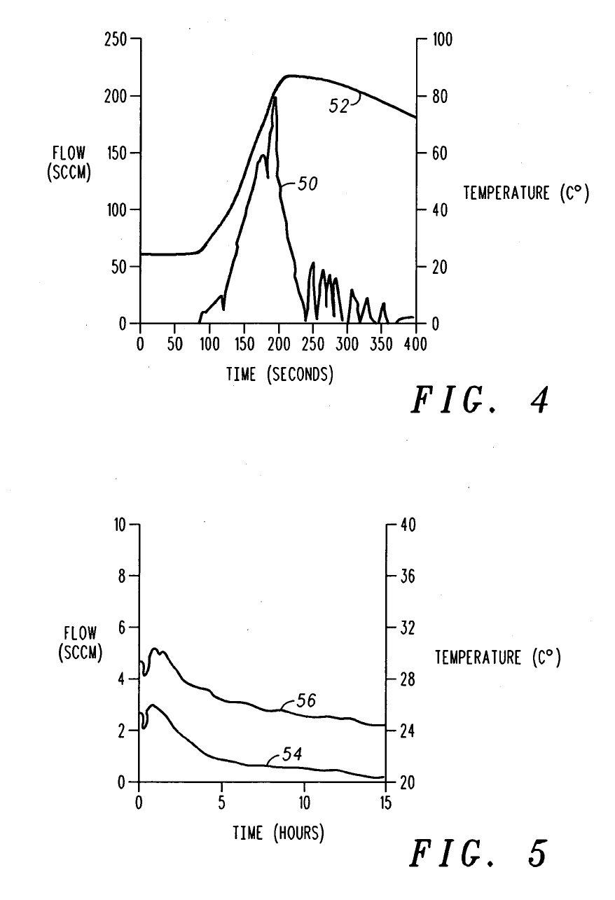

One previously known method of applying water droplets to a solid fuel results in a hydrogen flow 50 and temperature 52 shown in FIG. 4. The temperature 52 in this known example exceeds 80° C. and the flow 50 has a single peak at about 200 standard cubic centimeters per minute (sccm) where “standard” is referenced to 0° C. and 760 Torr, over a period of a couple hundred of seconds. A graph showing the flow rate 54 and temperature 56 of the exemplary embodiment described herein is shown in FIG. 5. The temperature 56 remains below 31° C. and the flow rate 54 remains generally below 3.5 sccm, and more generally much lower over a period of several hours. It may be seen that the exemplary embodiment controls the reaction rate between the fuel and water, thereby maintaining a desired rate of about 1.0 to 3.0 sccm for example, at a low temperature. In this exemplary embodiment, by providing the water in the form of adsorbed water from the polymer crystals, the rate of reaction of water with the sodium borohydride fuel pellet is diffusion controlled, maintaining a steady slow release of hydrogen without excessive temperature generation. For a consumer device designed to be carried by people and designed to fit in a small volume, excessive temperatures are not desirable. Matching the hydrogen generation rate to the desired fuel cell consumption rate eliminates leaking of hydrogen (safety hazard) and difficult storing issues of hydrogen gas until it is consumed by the fuel cell. By keeping the reactants separate in small quantities, accidental release of too much hydrogen gas or excessive temperature generation are eliminated. The exemplary embodiment provides for the flexibility of starting the fuel cells to generate power only when it is needed. If the electronic device that is being powered by the fuel cell is in a standby mode and not much power is required, there is not a need to generate power from the fuel cell and not a need to generate hydrogen gas. Further fuel reaction in other small chambers will be stopped until there is a need for the hydrogen source.

FIGS. 6-14 illustrate an exemplary process to fabricate a micro-fuel cell 38 with a semiconductor process on silicon, glass, ceramic, plastic, or a flexible substrate that may utilize the exemplary embodiment described above. Referring to FIG. 6, a thin layer 114 of titanium is deposited on a substrate 112 to provide adhesion for subsequent metallization layers and may also be an electrical back plane (for I/O connections, current traces). The layer 114 may have a thickness in the range of 10-1000 Å, but preferably is 100 Å. Metals other than titanium may be used, e.g., tantalum, molybdenum, tungsten, chromium. A first metal layer 116 is deposited on the layer 114 for good conduction and preferably is gold since it is a noble metal more suitable in the oxidizing reducing atmospheres seen during the operation of the fuel cell.

Referring to FIG. 7, the gold layer 116 is then patterned and etched for providing contacts to elements described hereinafter (alternatively, a lift off process could be used), and an oxide layer 118 is deposited thereon. A second metal layer 120, e.g., gold, is deposited on the layer 118 and patterned and etched for providing contacts to elements described hereinafter. The layer 116 may have a thickness in the range of 100 Å-1.0 micrometer, but preferably is 1000 Å. Metals for the first and second metal layers other than gold, may include, e.g., platinum, silver, palladium, ruthenium, nickel, copper. A via 115 is then created and filled with metal to bring the electrical contact of gold layer 116 to the surface 119 of dielectric layer 118.

A multi-metal layer 122 comprising an alloy of two metals, e.g., silver/gold, copper/silver, nickel/copper, copper/cobalt, nickel/zinc and nickel/iron, and having a thickness in the range of 100-500 um, but preferably 200 um, is deposited on the layer 116. The multi-metal layer 118 is then wet etched to remove one of the metals, leaving behind a porous material. The porous metal layer could also be formed by other methods such as templated self assembled growth or sol-gel methods. A dielectric layer 120 is deposited on the layer 118 and a resist layer 122 is patterned in a manner well known to those in the industry on the dielectric layer 120.

Referring to FIG. 8, multi-metal layer 122 comprising an alloy of two metals, e.g., silver/gold, copper/silver, nickel/copper, copper/cobalt, nickel/zinc and nickel/iron, and having a thickness in the range of 100-500 um, but preferably 200 um, is deposited on the metal layer 120 and a seed layer (not shown) above oxide layer 118. A dielectric layer 124 is deposited on the multi-metal layer 122 and a resist layer 126 is patterned and etched on the dielectric layer 124.

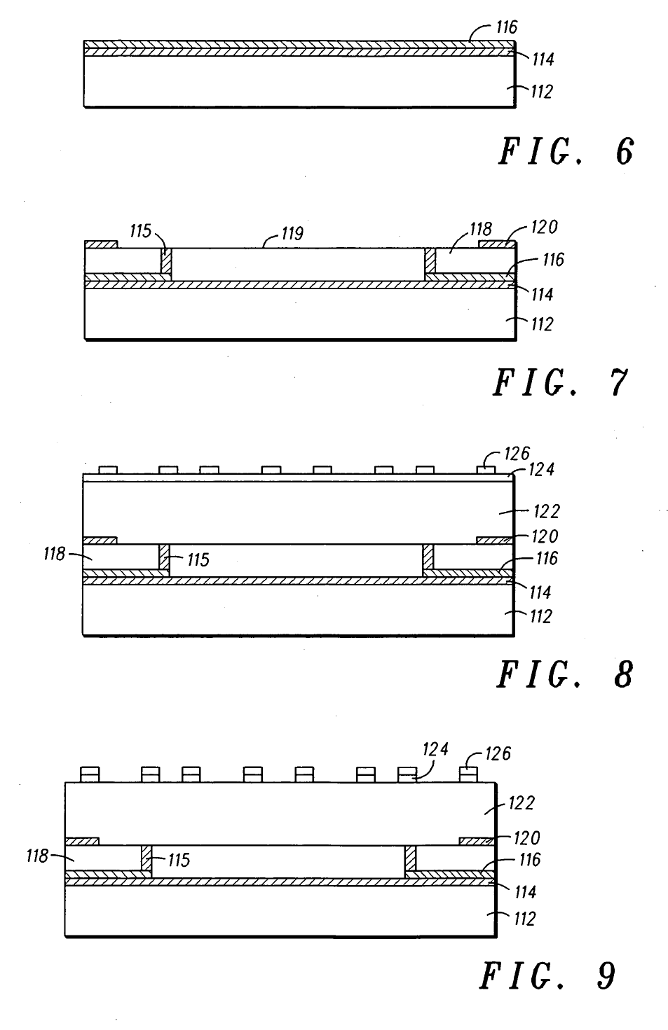

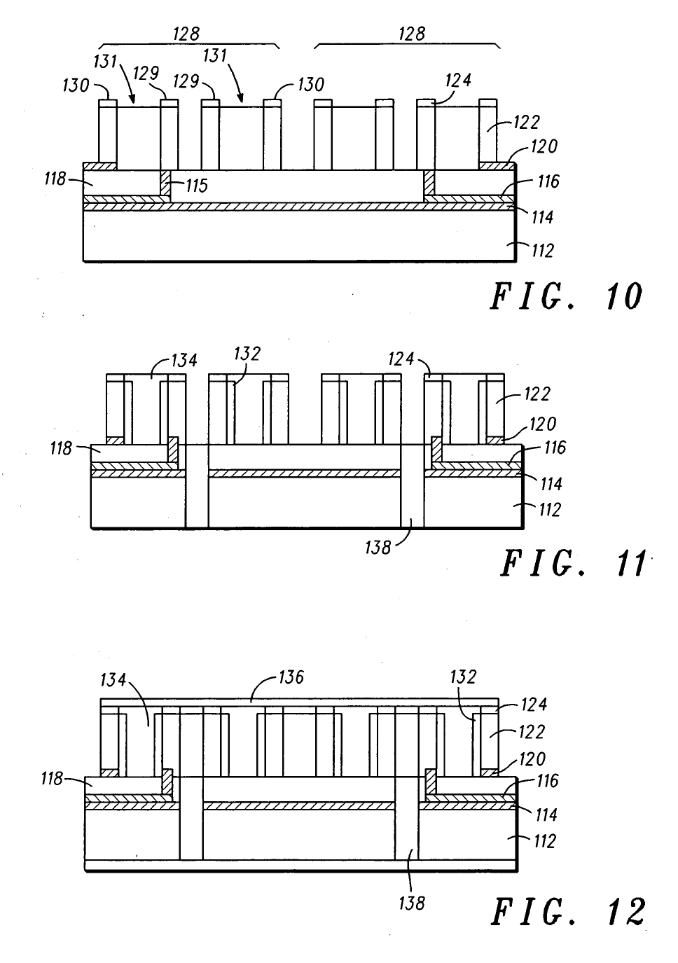

Referring to FIGS. 9-10, using a chemical etch, the dielectric layer 124 not protected by the resist layer 126, is removed. Then, after the resist layer 126 is removed, the multi-metal layer 122, not protected by the dielectric layer 124, are removed to form a pedestal 128 comprising a center anode 129 (inner section) and a concentric cathode 130 (outer section) surrounding, and separated by a cavity 131 from, the anode 129. The pedestal 128 preferably has a diameter of 10 to 100 microns. The distance between each pedestal 128 would be 10 to 100 microns, for example. Alternatively, the anode 129 and cathode 130 may be formed simultaneously by templated processes. In this process, the pillars will be fabricated using a photoresist or other template process followed by a multi-layer metal deposition around the pillars forming the structure shown in FIG. 10. Concentric as used herein means having a structure having a common center, but the anode, cavity, and cathode walls may take any form and are not to be limited to circles. For example, the pedestals 128 may alternatively be formed by etching orthogonal trenches.

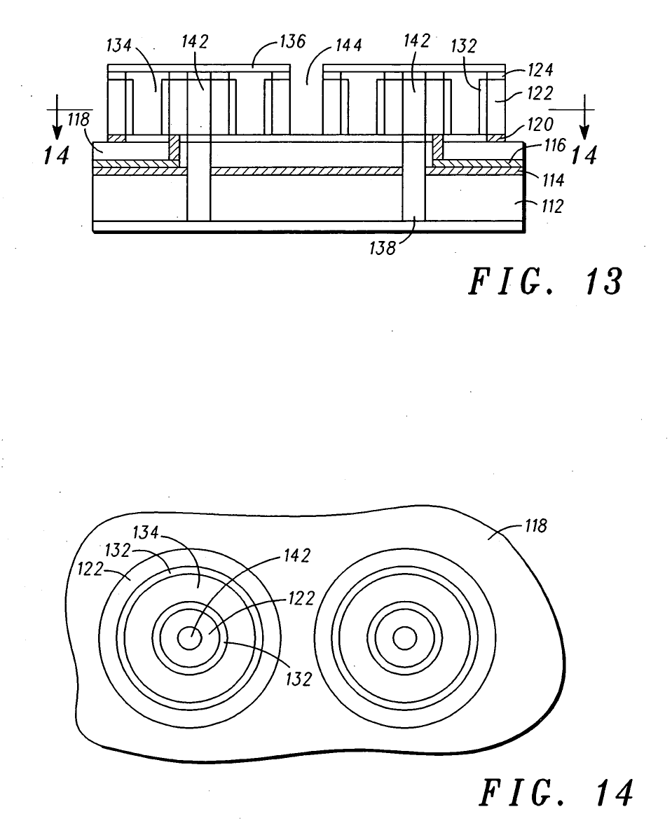

The side walls 132 are then coated with an electrocatalyst for anode and cathodic fuel cell reactions by wash coat or some other deposition methods such as CVD, PVD or electrochemical methods (FIG. 11). Then the layers 114 and 116 are etched down to the substrate 112 and an electrolyte material 134 is placed in the cavity 131 before a capping layer 136 is formed (FIG. 12) and patterned (FIG. 13) above the electrolyte material 134. Alternatively, the electrolyte material 134 may comprise, for example, perflurosulphonic acid (Nafion®), phosphoric acid, or an ionic liquid electrolyte. Perflurosulphonic acid has a very good ionic conductivity (0.1 S/cm) at room temperature when humidified. The electrolyte material also can be a proton conducting ionic liquids such as a mixture of bistrifluromethane sulfonyl and imidazole, ethylammoniumnitrate, methyammoniumnitrate of dimethylammoniumnitrate, a mixture of ethylammoniumnitrate and imidazole, a mixture of elthylammoniumhydrogensulphate and imidazole, flurosulphonic acid and trifluromethane sulphonic acid. In the case of liquid electrolyte, the cavity needs to be capped to protect the electrolyte from leaking out.

A via, or cavity, 138 is formed (FIG. 12) in the substrate 112 by chemical etching (wet or dry) methods. Then, using chemical or physical etching methods, the via 138 is extended through the layer 114 and 116 to the multi-metal layer 122.

FIG. 14 illustrates a top view of adjacent fuel cells fabricated in the manner described in reference to FIGS. 5-13. The silicon substrate 112, or the substrate containing the micro fuel cells, is positioned on a structure 140 for transporting hydrogen to the cavities 138. The structure 140 may comprise a cavity or series of cavities (e.g., tubes or passageways) formed in a ceramic material, for example. Hydrogen would then enter the hydrogen sections 142 of alternating multi-metal layer 122 above the cavities 138. Since sections 142 are capped with the dielectric layer 120, the hydrogen would stay within the sections 142. Oxidant sections 144 are open to the ambient air, allowing air (including oxygen) to enter oxidant sections 144.

After filling the cavity 134 with the electrolyte material, it will form a physical barrier between the anode (hydrogen feed) and cathode (air breathing) regions. Gas manifolds are built into the bottom packaging substrate to feed hydrogen gas to all the anode regions. Since it is capped on the top 136, it will be like a dead end anode feed configuration fuel cell. The fuel source described in FIGS. 1-3 fits under the fuel cell package and the H₂ gas outlet from the source couples to the fuel inlet of the fuel cells. The sodium borohydride fuel and water reaction produces hydrogen at the desired rate. After generating hydrogen gas, a byproduct NaBO₂ and the polymer crystals will be left in the disposable fuel cartridge which. New fuel cartridges can be inserted into the power source to supply hydrogen gas as desired. The choice of the fuel (solid fuel source) and the other reactant (water) in a convenient form (adsorbed in a polymer) and packaged into small reaction chambers separated by a controlled valve which can be opened as desired for the reaction to proceed in a safe, slow rate to produce hydrogen gas at the desired 1-3 sccm rate needed for micro fuel cells is taught herein.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A storage apparatus for storing a fuel source and water for supplying a fuel to a fuel cell, the storage apparatus comprising:
a housing defining a fuel source chamber and a plurality of water chambers;
at least one polymer crystal containing water positioned within each of the water chambers;
a solid fuel positioned within the fuel source chamber;
wherein the water in each of the water chambers is selectively allowed to migrate to the fuel source chamber to contact the solid fuel to produce the fuel at a desired flow rate and temperature; and
a conduit for supplying the fuel produced within the housing to the fuel cell.

2. The storage apparatus of claim 1 wherein the fuel source chamber comprises a plurality of fuel source chambers, wherein the solid fuel is positioned within each of the fuel source chambers.

3. The storage apparatus of claim 1 wherein the solid fuel comprises a chemical hydride.

4. The storage apparatus of claim 1 wherein the solid fuel comprises sodium borohydride.

5. The storage apparatus of claim 4 wherein the solid fuel also includes a catalyst.

6. The storage apparatus of claim 1 further comprising a valve positioned between each of the plurality of water chambers and the fuel chamber.

7. The storage apparatus of claim 6 wherein the valve is activated electromagnetically, electrostatically, or by resistive methods.

8. The storage apparatus of claim 1 further comprising an electrical conductor connected to each of the valves.

9. The storage apparatus of claim 1 further comprising circuitry coupled to the fuel cell for detecting whether an electrical output of the fuel cell exceeds a threshold and thereby selecting one of the water chambers for supplying water to the fuel source.

10. A fuel cell comprising:
a storage apparatus comprising:
a housing defining a plurality of water chambers and a fuel source chamber;
at least one polymer crystal containing water positioned within each of the water chambers;
a solid fuel positioned within the fuel source chamber;
wherein the water in each of the water chambers is selectively allowed to migrate to the fuel source chamber to contact the solid fuel to produce the fuel at a desired flow rate and temperature; and
a conduit for supplying the fuel produced within the housing to the fuel cell;
a sensor for sensing when the electrical output of the fuel cell exceeds a threshold; and
logic circuitry selecting, in response to the threshold being exceeded, one of the water chambers and causing the water therein to migrate to the fuel source.

11. The storage apparatus of claim 10 wherein the fuel source chamber comprises a plurality of fuel source chambers, wherein the solid fuel is positioned within each of the fuel source chambers.

12. The storage apparatus of claim 10 wherein the solid fuel comprises a chemical hydride.

13. The storage apparatus of claim 10 wherein the solid fuel comprises sodium borohydride.

14. The storage apparatus of claim 13 wherein the solid fuel also includes a catalyst.

15. The storage apparatus of claim 10 further comprising a valve positioned between each of the plurality of water chambers and the fuel chamber.

16. The storage apparatus of claim 15 wherein the valve is activated electromagnetically, electrostatically, or by resistive methods.

17. The storage apparatus of claim 10 further comprising an electrical conductor connected to each of the valves.

18. The storage apparatus of claim 10 further comprising circuitry coupled to the fuel cell for detecting whether an electrical output of the fuel cell exceeds a threshold and thereby selecting one of the water chambers for supplying water to the fuel source.

19. A method of supplying a fuel to a fuel cell comprising:
sensing when an electrical output of the fuel cell exceeds a threshold;
selecting one of a plurality of water chambers containing at least one polymer crystal containing water;
causing the water to migrate from the selected water chamber to a fuel source comprising a chemical hydride mixed with a catalyst;
producing the fuel from the mixing of the water and the fuel source;
supplying the fuel to the fuel cell.

20. The storage apparatus of claim 19 wherein the fuel source is stored in a plurality of fuel source chambers and wherein the solid fuel is positioned within each of the fuel source chambers, and the causing step comprises causing the water from the selected water chamber to migrate to one of the plurality of fuel source chambers.

21. The storage apparatus of claim 19 further comprising:
detecting whether an electrical output of the fuel cell exceeds a threshold; and
selecting one of the water chambers for supplying water to the fuel source.
